(19) United States
(12) Patent Application Publication
(10) Pub. No.: US 2006/0253877 A1
(43) Pub. Date: Nov. 9, 2006

(54) Method of automatically selecting a satellite to lock onto

(76) Inventor: Chiao-Fang Hsu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 10/908,297

(22) Filed: May 5, 2005

(51) Int. Cl. H04N 7/20; H04N 7/16

(52) U.S. Cl. 725/68; 725/63; 725/25

(57) ABSTRACT

A method of selecting a satellite to lock onto for receiving signals from the satellite is disclosed, wherein the satellite has at least one transponder. The method comprises the steps of providing a database recorded with a list of a plurality of satellites, and a plurality of reception parameters corresponding to the transponder of each satellite in the list of satellites; utilizing the reception parameters corresponding to the transponder of one of the satellites as a configuration setting; detecting if the configuration setting is capable of receiving signals transmitted from the corresponding transponder of the satellite; and selecting the detected satellite to lock onto according to the configuration setting.

### BACKGROUND OF INVENTION

1. Field of the Invention

The present invention relates to satellite television, and more specifically, to a method of automatically selecting a satellite to lock onto based on the quality of received satellite signals.

2. Description of the Prior Art

Traditionally, when a user subscribes to a satellite television (TV) service, a technician will come over to the user's house to install a satellite dish and a set-top box. Please refer to FIG. 1 . FIG. 1 is a diagram of a satellite TV system 10 according to the prior art. In the satellite TV system 10, a satellite dish 12 is connected to a set-top box 16 through a cable 14. A TV 18 is connected to the set-top box 16 so that the user can view satellite TV programs through the TV 18. The technician installs the satellite dish 12 and positions it so that the satellite dish 12 is able to receive satellite signals from a satellite orbiting the Earth. In addition, the technician configures the set-top box 16 to have the proper reception parameters for receiving signals from each transponder of the selected satellite. In this satellite TV system 10, the user does not need to go through any complicated setup steps because the technician is the person responsible for setup.

Some users prefer to watch satellite TV on their computer instead of on a TV. Please refer to FIG. 2. FIG. 2 is a diagram of a system 20 for watching satellite TV on a computer 22 according to the prior art. In the system 20, the computer 22 contains a TV tuner card 24, and the cable 14 is directly connected to the TV tuner card 24 for allowing satellite TV to be received on the computer 22. Presently, when the user buys the TV tuner card 24 for the computer 22 in order to receive satellite TV signals, the satellite reception parameters for the computer 22 must be setup manually. Unfortunately, the average user is not usually able to perform this setup process by himself because of the large number of parameters that must be setup. For example, the user must first decide which satellite his satellite dish 12 is pointing at. This in itself is not an easy task since there are over 180 satellites orbiting the Earth above the equator. Once the correct satellite has been selected, the user must then key in the reception parameters for each transponder in the selected satellite along with other reception parameters such as downlink frequency, symbol rate, etc. Clearly, a simpler setup routine is needed in which the user can buy a TV tuner card, install it in his computer, and quickly and easily configure the computer to start receiving satellite TV signals.

### SUMMARY OF INVENTION

It is therefore an objective of the claimed invention to provide a method for automatically selecting a satellite to lock onto in order to solve the above-mentioned problems.

According to the claimed invention, a method of selecting a satellite to lock onto for receiving signals from the satellite is disclosed, wherein the satellite has at least one transponder. The method comprises the steps of providing a database recorded with a list of a plurality of satellites, and a plurality of reception parameters corresponding to the transponder of each satellite in the list of satellites; utilizing the reception parameters corresponding to the transponder of one of the satellites as a configuration setting; detecting if the configuration setting is capable of receiving signals transmitted from the corresponding transponder of the satellite; and selecting the detected satellite to lock onto according to the configuration setting.

According to the claimed invention, a method of selecting a satellite to lock onto for receiving signals from the satellite is disclosed, wherein the satellite has at least one transponder. The method comprises the steps of providing a database recorded with a list of a plurality of satellites, and a plurality of reception parameters corresponding to the transponder of each satellite in the list of satellites; utilizing the reception parameters corresponding to the transponder of one of the satellites as a configuration setting; detecting if the configuration setting is capable of receiving signals transmitted from the corresponding transponder of the satellite; accumulating the number of detected transponders of each satellite; and selecting the satellite containing the highest percentage of locked transponders.

It is an advantage of the claimed invention that the satellite with the strongest signal is automatically selected for the user. Moreover, the reception parameters needed for communicating with the selected satellite are read from a database, eliminating the need for a user to manually enter the reception parameters. In this way, the claimed invention simplifies the task of setting up a satellite TV system.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a satellite TV system according to the prior art.

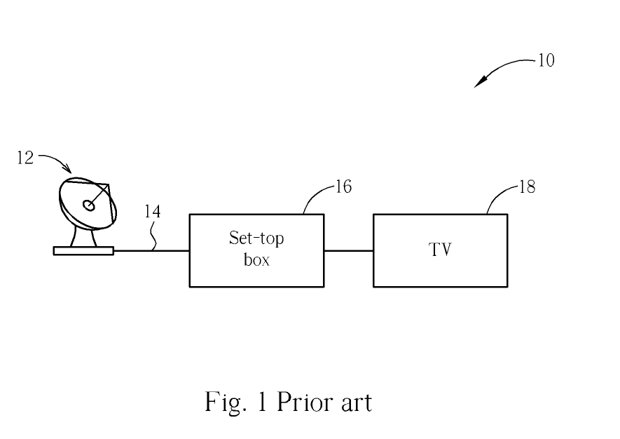

FIG. 2 is a diagram of a system for watching satellite TV on a computer according to the prior art.

FIG. 3 illustrates a system for watching satellite TV using a TV tuner card according to the present invention.

FIG. 4 is a diagram showing the position of a satellite above Earth.

### DETAILED DESCRIPTION

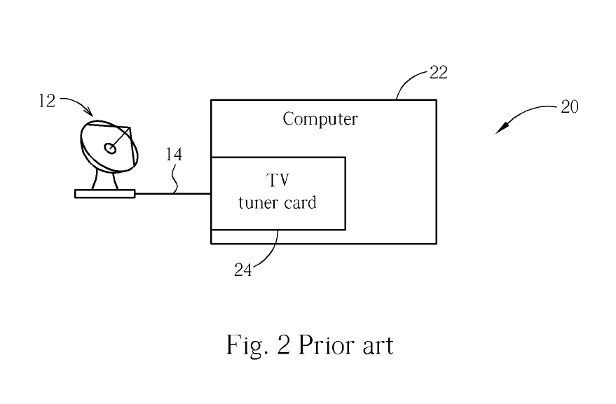

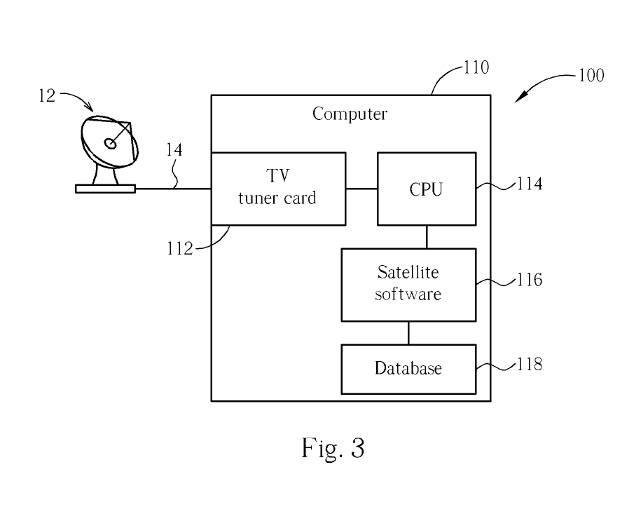

Please refer to FIG. 3. FIG. 3 illustrates a system 100 for watching satellite TV using a TV tuner card 112 according to the present invention. Like the system 20 shown in FIG. 2, the TV tuner card 112 is installed in a computer 110, and receives signals from the satellite dish 12 via the cable 14. When a user installs the TV tuner card 112 in the computer 110, the user also installs a satellite software program 116 to help configure the TV tuner card 112 to receive satellite signals.

The satellite software program 116 also installs a database 118 in the computer 110, the database 118 containing a list of satellites orbiting above the Earth and satellite reception parameters corresponding to the transponder of each satellite in the list of satellites. Some of the parameters required for receiving satellite signals include downlink frequency, symbol rate, forward error correction (FEC), and polarization. The database 118 stores parameters needed for receiving signals from each transponder of each satellite used for broadcasting satellite TV. The database 118 is initially loaded into the computer 110 when the satellite software program 116 is installed, and can be updated in the future by loading or downloading the new parameters into the computer 110. A central processing unit (CPU) 114 controls operation of the computer 110, executes the satellite software program 116, and facilitates communication between the TV tuner card 112 and the satellite software program 116, thereby enabling the computer 110 to be used to watch satellite TV programming.

The present invention solves the prior art problem of forcing the user to manually select a satellite to receive signals from and to enter the reception parameters corresponding to the selected satellite. The present invention uses a multiple step process for automatically selecting a satellite and configuring the computer 110 to watch satellite TV.

First of all, a filtering process can be optionally performed for narrowing down the satellites to be searched. Since there are more than 180 satellites orbiting above the earth, reducing the number of satellites that are searched will save considerable time instead of measuring the signal strength of every single satellite.

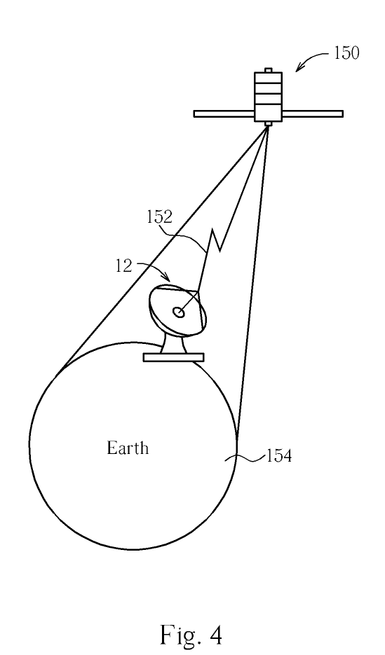

Please refer to FIG. 4. FIG. 4 is a diagram showing the position of a satellite 150 above Earth 154. The satellite 150 has a coverage angle of about 120 degrees with respect to the Earth 154, meaning that the satellite 150 is theoretically capable of providing satellite signals to about one-third of the Earth 154. Therefore, the satellite dish 12 shown can only receive satellite signals 152 from about 60 satellites, which is one-third of the total 180 satellites above the Earth 154. By comparing the user's geographical location to the information stored in the database 118 that indicates the geographical location of the satellites orbiting the Earth 154, the number of satellites to be searched can be narrowed down to about one-third of the total number. The user's geographical location is most easily extracted from location information present in the computer 110. For instance, when initially setting up the operating system of the computer 110, the user enters time zone information, the country that the user resides in, telephone area code information, etc. The satellite software program 116 can automatically determine the user's geographical location from this data without any further input needed from the user. On the other hand, when installing the satellite software program 116, the satellite software program 116 can also prompt the user to enter his geographical location, and use this location for filtering down the number of satellites to be searched. Although this filtering step is optional, being able to reduce the number of satellites searched will greatly reduce the amount of time needed to successfully select a satellite and configure the computer 110 to receive satellite TV signals from the selected satellite.

The next step in the process is testing the received signal strength of the satellites one satellite at a time. To do this, the system 100 attempts to lock onto as many transponders of each satellite as possible. The reception parameters, which are stored in the database 118, corresponding to the various satellite transponders are loaded one at a time for configuring the system 100 to communicate with satellite transponders. Then this configuration setting is used to attempt to communicate with the corresponding transponder of the satellite. Once the system 100 has successfully communicated with a satellite's transponder, the system 100 can then select this satellite to lock onto.

However, there may be transponders on other satellites that the system 100 is able to communicate with. For best results, it is necessary to try communicating with each available satellite. Therefore, the present invention aims to select the satellite that provides the best reception to the system 100. Each time a transponder is locked onto for a given satellite, a total number of locked transponders corresponding to that satellite is incremented. A total number of locked transponders is calculated for each satellite to determine which satellite provides the best signal strength to the system 100.

A satellite with the strongest signal strength is then chosen to be the satellite that the system 100 will be setup to receive signals from. The chosen satellite can either be the satellite with the highest number of locked transponders, or the satellite having the highest percentage of locked transponders out of all the transponders available on that satellite. In either case, the data indicating the total number of locked transponders should make it very clear which satellite will provide the best signal reception. Once the best satellite has been chosen, the user can then begin watching TV programs broadcast from the chosen satellite.

In contrast to the prior art, the claimed invention automatically selects the satellite which provides the best signal reception, and configures the user's computer with the proper parameters for receiving signals from the selected satellite. In this way, the user does not need to manually select the satellite or manually input the reception parameters. By selecting the satellite which provides the most locked transponders, the present invention method provides a reliable way to select the best satellite available while at the same time minimizing the amount of work required by the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of selecting a satellite to lock onto for receiving signals from the satellite, wherein the satellite has at least one transponder, the method comprising the steps of:
providing a database recorded with a list of a plurality of satellites, and a plurality of reception parameters corresponding to the transponder of each satellite in the list of satellites;
utilizing the reception parameters corresponding to the transponder of one of the satellites as a configuration setting;
detecting if the configuration setting is capable of receiving signals transmitted from the corresponding transponder of the satellite; and
selecting the detected satellite to lock onto according to the configuration setting.

2. The method of claim 1, wherein the step of utilizing the reception parameter corresponding to the transponder of one of the satellites as a configuration setting further comprises filtering the list of satellites according to the location of the satellites for selecting a set of satellites closest to the location of a satellite dish used to lock onto the satellites.

3. The method of claim 1, wherein the step of utilizing the reception parameter corresponding to the transponder of one of the satellites as a configuration setting further comprises filtering the list of satellites according to the location of the satellites for selecting only satellites for which a satellite dish used to lock onto the satellites is in the coverage range of the selected satellite.

4. The method of claim 1, wherein in the detecting step, if more than one satellite is detected, the method further comprises locking onto the satellite containing the highest number of detected transponders.

5. The method of claim 4, wherein locking onto the satellite containing the highest number of locked transponders comprises locking onto the satellite containing the highest percentage of locked transponders.

6. A method of selecting a satellite to lock onto for receiving signals from the satellite, wherein the satellite has at least one transponder, the method comprising the steps of:
providing a database recorded with a list of a plurality of satellites, and a plurality of reception parameters corresponding to the transponder of each satellite in the list of satellites;
utilizing the reception parameters corresponding to the transponder of one of the satellites as a configuration setting;
detecting if the configuration setting is capable of receiving signals transmitted from the corresponding transponder of the satellite;
accumulating the number of detected transponders of each satellite; and
selecting the satellite containing the highest percentage of locked transponders.

7. The method of claim 6, wherein the step of utilizing the reception parameter corresponding to the transponder of one of the satellites as a configuration setting further comprises filtering the list of satellites according to the location of the satellites for selecting a set of satellites closest to the location of a satellite dish used to lock onto the satellites.

8. The method of claim 6, wherein the step of utilizing the reception parameter corresponding to the transponder of one of the satellites as a configuration setting further comprises filtering the list of satellites according to the location of the satellites for selecting only satellites for which a satellite dish used to lock onto the satellites is in the coverage range of the selected satellite.

9. The method of claim 6, wherein accumulating the number of detected transponders of each satellite comprises attempting to communicate with the satellites one satellite at a time.
